(19) United States
(12) Patent Application Publication
(10) Pub. No.: US 2025/0107479 A1
(43) Pub. Date: Apr. 3, 2025

(54) MULTIMODAL MODEL FOR AGRICULTURAL INSIGHT MINING FROM TIME SERIES AGRICULTURAL INFORMATION

(71) Applicant: Deere & Company, Moline, IL (US)

(72) Inventors: Yawen Zhang, Mountain View, CA (US); Yunkai Zhang, Santa Clara, CA (US); Kezhen Chen, San Mateo, CA (US); Ming Zheng, Redwood City, CA (US); Jinmeng Rao, Sunnyvale, CA (US); Xiaoyuan Guo, Palo Alto, CA (US); Hongxu Ma, San Jose, CA (US); Jie Yang, Sunnyvale, CA (US); Christopher Grant Padwick, Menlo Park, CA (US)

(21) Appl. No.: 18/905,001

(22) Filed: Oct. 2, 2024

Related U.S. Application Data
(60) Provisional application No. 63/542,208, filed on Oct. 3, 2023.

(51) Int. Cl. A01B 79/02; A01B 79/00; G06F 40/20

(52) U.S. Cl. CPC A01B 79/02; A01B 79/005; G06F 40/20

(57) ABSTRACT

Systems and methods herein present a multi-modal model, or insight miner, for agricultural use. The model is used for generating actionable insights from time-series agricultural data. To do so, a control system of a farming machine includes the insight miner and a training module. The miner ingests agricultural information (e.g., time series field measurements), identifies trends in the time-series data (e.g., increasing, decreasing, etc.), and determines potential farming actions to take based on identified trends. To do so, the model generates visual representations of the time-series data, inputs the visual representations into a model to obtain a natural language description of that data, and enact farming actions based on the insights obtained. The training module trains the model by generating visual representation and natural language pairs, which are used to train the model.

### CROSS REFERENCE TO RELATED APPLICATIONS

This application claims the benefit of U.S. Provisional Application No. 63/542,208, filed Oct. 3, 2023, which is incorporated by reference in its entirety.

### BACKGROUND

### Field of Disclosure

This disclosure relates to the field of analyzing time-series agronomy information with language models, and, more specifically, to generating natural language descriptions of trends in time-series agronomy information and identifying farming actions to perform in the field based on those natural language descriptions.

### Description of Related Art

Presently, modern farming relies heavily on various technological tools and data analytics to make informed decisions about farming practices. This includes machinery used for seeding, fertilization, harvesting, and more. The data used to inform these decisions come from a multitude of sources, including sensors embedded in the machinery, external environment sensors, historical agricultural data, and more. These data are often time-series data which involves observations collected at regular intervals over time.

Having the ability to make accurate and timely observations about such data can provide valuable insights that can improve efficiency and productivity on the farm. Additionally, the insights derived can help to predict future agricultural events, thus offering a proactive approach to farming. However, to date, the systems and methods used for processing and analyzing time-series data in an agricultural setting have been sub-optimal. Existing systems often do not fully utilize the available data, and as such, do not provide comprehensive or actionable insights. Moreover, it is challenging to identify trends and hidden correlations in the data to make informative decisions.

Thus, there is a need for an improved method of generating actionable insights from time-series agricultural data. The present invention addresses these problems by providing a multi-modal model (insight miner) capable of generating as well as acting upon these insights for better agricultural outcomes.

### SUMMARY

The system and methods herein provide a multimodal model for agricultural use (e.g., “insight miner”). The model is designed to mine actionable insights from time-series agricultural data. The model executes this function through an agriculturally oriented control system on a farming machine composed of the insight miner and a training module.

The insight miner performs a three-stage process of information ingestion, trend identification, and farming action identification using the ingested agricultural data. Through these stages, the miner processes agricultural data, identifies trends in the data, and identifies tangible actions based on these trends to improve agricultural productivity.

More robustly, at the ingestion stage, agricultural data is input or accessed by the insight miner. The data can range from histories of farming actions taken in a field, environmental measurements, farming machine sensor readings, among others. This accessed agricultural information is generally time-series data, hence describing relevant agronomic characteristics over time. At the trend identification stage, the model creates a visual representation of the data, which is input into an insight recognition model. The model outputs a simple natural language response describing the time-series data. At the action determination stage, the insight miner identifies possible actions to take in the field based on the natural language response. The training module generates training data for training the insight miner.

In some aspects, the techniques described herein relate to a method for performing one or more farming actions in a field, the method including: accessing agricultural information including time-series information describing agricultural events or agricultural measurements; generating a graphical representation of the agricultural information, the graphical representation displaying the time-series information; applying an insight identification model to the graphical representation of the agricultural information to generate a language response describing the agricultural information therein, the insight identification model: generating a language embedding of the graphical representation by inputting the graphical representation into a vision encoder; and generating the language response describing the time-series information by inputting the language embeddings and natural language instructions into a language model; and performing, with a farming machine, the one or more farming actions in the field based on the language response from the insight identification model.

In some aspects, the techniques described herein relate to a method, further including: receiving, from a manager of the field or an operator of the farming machine, natural language instructions for the language response.

In some aspects, the techniques described herein relate to a method, wherein accessing the agricultural information further includes: determining, based on the natural language instructions, one or more data sources for the time-series information; and accessing, from the identified one or more data sources, the agricultural information.

In some aspects, the techniques described herein relate to a method, further including: generating, from the agricultural information, one or more time windows, each of the time windows including a temporal subset of the time-series information; and wherein the graphical representation of the agricultural information includes the temporal subset of the time-series information.

In some aspects, the techniques described herein relate to a method, further including: applying one or more pre-processing functions to the agricultural information to modify the agricultural information before the graphical representation is generated.

In some aspects, the techniques described herein relate to a method, further including: identifying, based on the language response describing the agricultural information in the graphical representation, the one or more farming actions to perform in the field.

In some aspects, the techniques described herein relate to a method, wherein identifying the one or more farming actions includes: transmitting the language response to an operator of the farming machine or a manager of the field; and responsive to the transmission, receiving the one or more farming actions to perform in the field.

In some aspects, the techniques described herein relate to a method, further including: accessing additional information describing a state of the farming machine; and applying an action identification model to the language response and the additional information to identify the one or more farming actions.

In some aspects, the techniques described herein relate to a method, further including: training the insight identification model by: accessing a plurality of time-series information datasets; for each time-series information dataset of the plurality of time-series information datasets, selecting a time window for the time-series information dataset, extracting a trendline for the time-series information dataset based on a detected seasonality in the time-series information, generating a language model representation of the trendline, generating a visual representation of the time-series information, and creating a training pair including the visual representation of the time-series information and the language model representation of the trendline; and training the insight identification model using training pairs for each time-series dataset of the plurality of time-series information datasets.

In some aspects, the techniques described herein relate to a method, wherein the insight identification model is a multimodal model, and generating the language embedding of the graphical representation further includes: mapping, using a linear projection layer of the vision encoder of the insight identification model, the graphical representation to a language embedding space to generate the language embedding.

### BRIEF DESCRIPTION OF DRAWINGS

FIG. 1A is an isometric view of a farming machine that performs farming actions of a treatment plan, in accordance with one example embodiment.

FIG. 1B is a top view of the farming machine in FIG. 1A, in accordance with one example embodiment.

FIG. 1C is an isometric view of another farming machine that performs farming actions of a treatment plan, in accordance with one example embodiment.

FIG. 2 is a block diagram of the system environment for the farming machine, in accordance with one or more example embodiments.

FIG. 3 illustrates a workflow for performing one or more farming actions in a field, in accordance with one or more example embodiments.

FIG. 4 illustrates a workflow for generating training an insight miner, in accordance with one or more example embodiments.

FIG. 5A illustrates time-series information describing weather information in a field in a time window, in accordance with one or more example embodiments.

FIG. 5B illustrates time-series information describing water flow in an irrigation source for a field in a time window, in accordance with one or more example embodiments.

FIG. 5C illustrates time-series information describing the power demand of a farming machine in a field in a time window, in accordance with one or more example embodiments.

FIG. 6 is a block diagram illustrating components of an example machine for reading and executing instructions from a machine-readable medium, in accordance with an example embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### I. Introduction

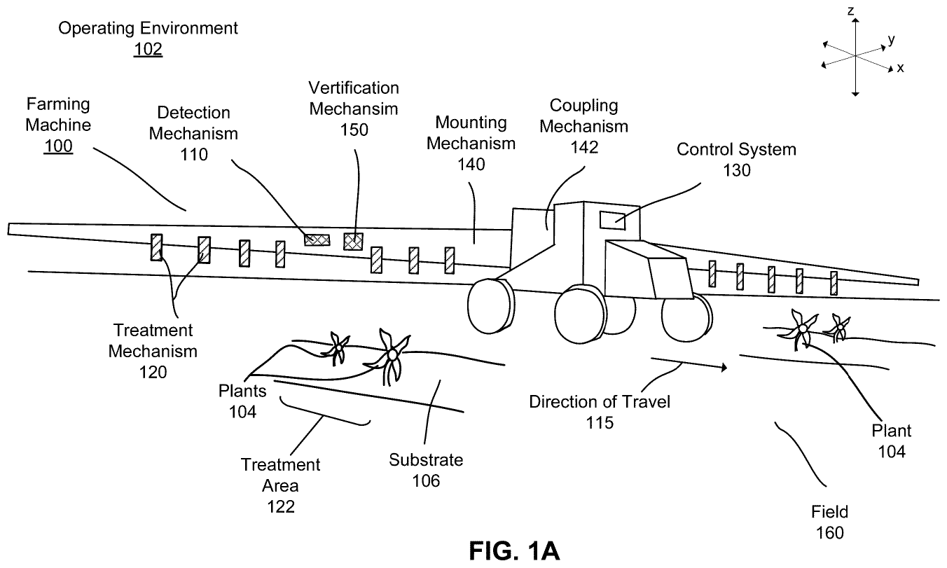

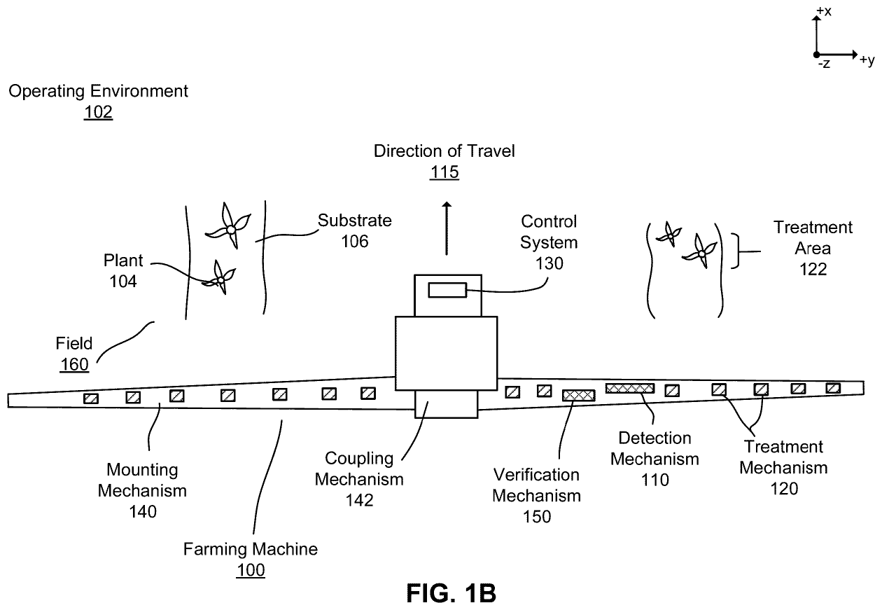

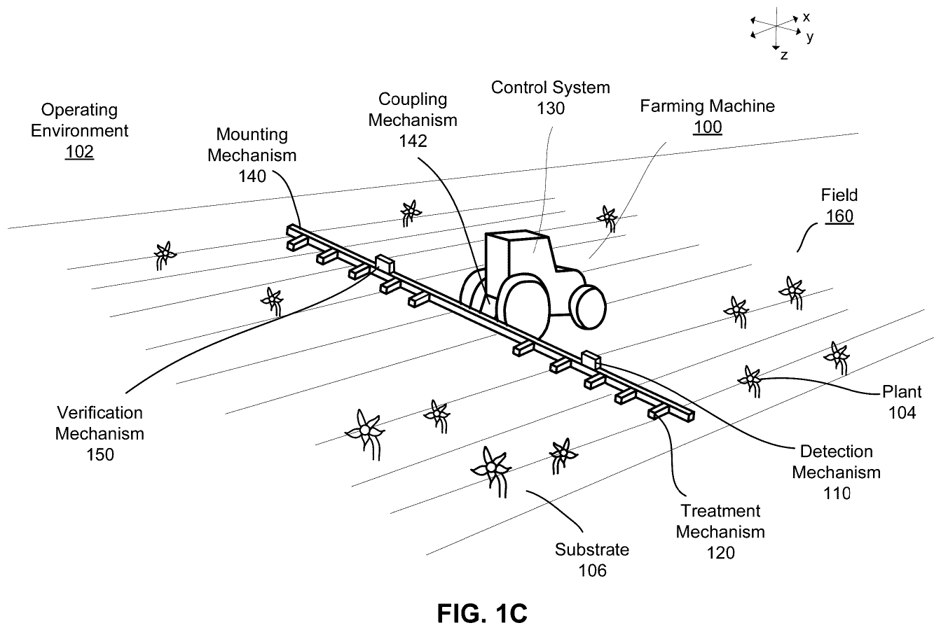

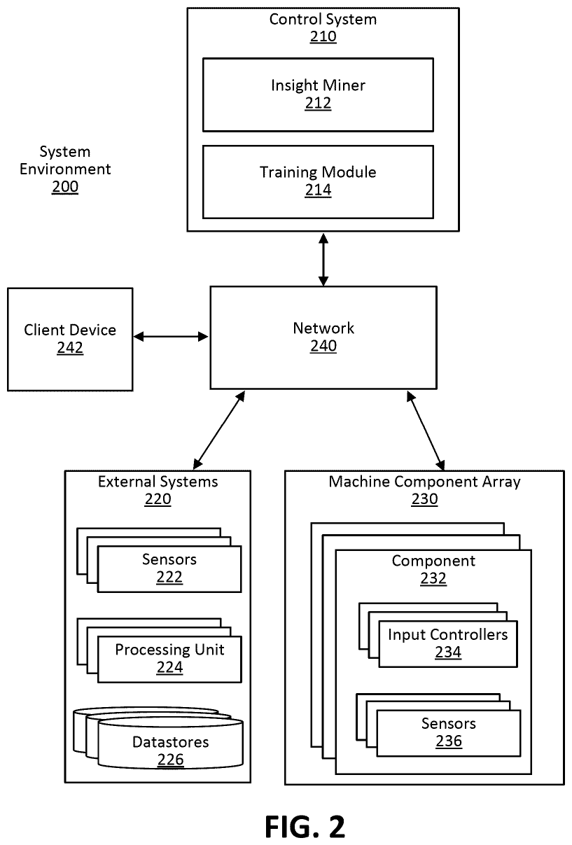

Embodiments relate to determining insights from time-series agricultural information and performing farming actions in the field based on the determined insight. FIGS. 1-2 describe general information related to example farming machines.

### II. Field Management and Treatment Plans

### Field Management

Agricultural managers (“managers”) are responsible for managing farming operations in one or more fields. Managers work to implement a farming objective within those fields and select from among a variety of farming actions to implement that farming objective. Traditionally, managers are, for example, a farmer or agronomist that works the field but could also be other people and/or systems configured to manage farming operations within the field. For example, a manager could be an automated farming machine, a machine learned computer model, etc. In some cases, a manager may be a combination of the managers described above. For example, a manager may include a farmer assisted by a machine learned agronomy model and one or more automated farming machines or could be a farmer and an agronomist working in tandem.

Managers implement one or more farming objectives for a field. A farming objective is typically a macro-level goal for a field. For example, macro-level farming objectives may include treating crops with growth promotors, neutralizing weeds with growth regulators, harvesting a crop with the best possible crop yield, or any other suitable farming objective. However, farming objectives may also be a micro-level goal for the field. For example, micro-level farming objectives may include treating a particular plant in the field, repairing or correcting a part of a farming machine, requesting feedback from a manager, etc. Of course, there are many possible farming objectives and combinations of farming objectives, and the previously described examples are not intended to be limiting.

Farming objectives are accomplished by one or more farming machines performing a series of farming actions. Farming machines are described in greater detail below. Farming actions are any operation implementable by a farming machine within the field that works towards a farming objective. Consider, for example, a farming objective of harvesting a crop with the best possible yield. This farming objective requires a litany of farming actions, e.g., planting the field, fertilizing the plants 104, watering the plants 104, weeding the field, harvesting the plants 104, evaluating yield, etc. Similarly, each farming action pertaining to harvesting the crop may be a farming objective in and of itself. For instance, planting the field can require its own set of farming actions, e.g., preparing the soil, digging in the soil, planting a seed, etc.

In other words, managers implement a treatment plan in the field to accomplish a farming objective. A treatment plan is a hierarchical set of macro-level and/or micro-level objectives that accomplish the farming objective of the manager. Within a treatment plan, each macro or micro-objective may require a set of farming actions to accomplish, or each macro or micro-objective may be a farming action itself. So, to expand, the treatment plan is a temporally sequenced set of farming actions to apply to the field that the manager expects will accomplish the faming objective.

When executing a treatment plan in a field, the treatment plan itself and/or its constituent farming objectives and farming actions have various results. A result is a representation as to whether, or how well, a farming machine accomplished the treatment plan, farming objective, and/or farming action. A result may be a qualitative measure such as “accomplished” or “not accomplished,” or may be a quantitative measure such as “40 pounds harvested,” or “1.25 acres treated.” Results can also be positive or negative, depending on the configuration of the farming machine or the implementation of the treatment plan. Moreover, results can be measured by sensors of the farming machine, input by managers, or accessed from a datastore or a network.

Traditionally, managers have leveraged their experience, expertise, and technical knowledge when implementing farming actions in a treatment plan. In a first example, a manager may spot check weed pressure in several areas of the field to determine when a field is ready for weeding. In a second example, a manager may refer to previous implementations of a treatment plan to determine the best time to begin planting a field. Finally, in a third example, a manager may rely on established best practices in determining a specific set of farming actions to perform in a treatment plan to accomplish a farming objective.

Leveraging manager and historical knowledge to make decisions for a treatment plan affects both spatial and temporal characteristics of a treatment plan. For instance, farming actions in a treatment plan have historically been applied to entire field rather than small portions of a field. To illustrate, when a manager decides to plant a crop, she plants the entire field instead of just a corner of the field having the best planting conditions; or, when the manager decides to weed a field, she weeds the entire field rather than just a few rows. Similarly, each farming action in the sequence of farming actions of a treatment plan are historically performed at approximately the same time. For example, when a manager decides to fertilize a field, she fertilizes the field at approximately the same time; or, when the manager decides to harvest the field, she does so at approximately the same time.

Notably though, farming machines have greatly advanced in their capabilities. For example, farming machines continue to become more autonomous, include an increasing number of sensors and measurement devices, employ higher amounts of processing power and connectivity, and implement various machine vision algorithms to enable managers to successfully implement a treatment plan.

Because of this increase in capability, managers are no longer limited to spatially and temporally monolithic implementations of farming actions in a treatment plan. Instead, managers may leverage advanced capabilities of farming machines to implement treatment plans that are highly localized and determined by real-time measurements in the field. In other words, rather than a manager applying a “best guess” treatment plan to an entire field, they can implement individualized and informed treatment plans for each plant in the field.

### III. Farming Machine

### Overview

A farming machine that implements farming actions of a treatment plan may have a variety of configurations, some of which are described in greater detail below.

FIG. 1A is an isometric view of a farming machine 100 that performs farming actions of a treatment plan, according to one example embodiment, and FIG. 1B is a top view of the farming machine 100 in FIG. 1A. FIG. 1C is an isometric view of another farming machine 100 that performs farming actions of a treatment plan, in accordance with one example embodiment.

The farming machine 100 includes a detection mechanism 110, a treatment mechanism 120, and a control system 130. The farming machine 100 can additionally include a mounting mechanism 140, a verification mechanism 150, a power source, digital memory, communication apparatus, or any other suitable component that enables the farming machine 100 to implement farming actions in a treatment plan. Moreover, the described components and functions of the farming machine 100 are just examples, and a farming machine 100 can have different or additional components and functions other than those described below.

The farming machine 100 is configured to perform farming actions in a field 160, and the implemented farming actions are part of a treatment plan. To illustrate, the farming machine 100 implements a farming action which applies a treatment to one or more plants 104 and/or the substrate 106 within a geographic area. Here, the treatment farming actions are included in a treatment plan to regulate plant growth. As such, treatments are typically applied directly to a single plant 104, but can alternatively be directly applied to multiple plants 104, indirectly applied to one or more plants 104, applied to the environment 102 associated with the plant 104 (e.g., soil, atmosphere, or other suitable portion of the plant's environment adjacent to or connected by an environmental factors, such as wind), or otherwise applied to the plants 104.

In a particular example, the farming machine 100 is configured to implement a farming action which applies a treatment that necroses the entire plant 104 (e.g., weeding) or part of the plant 104 (e.g., pruning). In this case, the farming action can include dislodging the plant 104 from the supporting substrate 106, incinerating a portion of the plant 104 (e.g., with directed electromagnetic energy such as a laser), applying a treatment concentration of working fluid (e.g., fertilizer, hormone, water, etc.) to the plant 104, or treating the plant 104 in any other suitable manner.

In another example, the farming machine 100 is configured to implement a farming action which applies a treatment to regulate plant growth. Regulating plant growth can include promoting plant growth, promoting growth of a plant portion, hindering (e.g., retarding) plant 104 or plant portion growth, or otherwise controlling plant growth. Examples of regulating plant growth includes applying growth hormone to the plant 104, applying fertilizer to the plant 104 or substrate 106, applying a disease treatment or insect treatment to the plant 104, electrically stimulating the plant 104, watering the plant 104, pruning the plant 104, or otherwise treating the plant 104. Plant growth can additionally be regulated by pruning, necrosing, or otherwise treating the plants 104 adjacent to the plant 104.

### Operating Environment 102

The farming machine 100 operates in an operating environment 102. The operating environment 102 is the environment 102 surrounding the farming machine 100 while it implements farming actions of a treatment plan. The operating environment 102 may also include the farming machine 100 and its corresponding components itself.

The operating environment 102 typically includes a field 160, and the farming machine 100 generally implements farming actions of the treatment plan in the field 160. A field 160 is a geographic area where the farming machine 100 implements a treatment plan. The field 160 may be an outdoor plant field but could also be an indoor location that houses plants such as, e.g., a greenhouse, a laboratory, a grow house, a set of containers, or any other suitable environment 102.

A field 160 may include any number of field portions. A field portion is a subunit of a field 160. For example, a field portion may be a portion of the field 160 small enough to include a single plant 104, large enough to include many plants 104, or some other size. The farming machine 100 can execute different farming actions for different field portions. For example, the farming machine 100 may apply an herbicide for some field portions in the field 160, while applying a pesticide in another field portion. Moreover, a field 160 and a field portion are largely interchangeable in the context of the methods and systems described herein. That is, treatment plans and their corresponding farming actions may be applied to an entire field 160 or a field portion depending on the circumstances at play.

The operating environment 102 may also include plants 104. As such, farming actions the farming machine 100 implements as part of a treatment plan may be applied to plants 104 in the field 160. The plants 104 can be crops but could also be weeds or any other suitable plant 104. Some example crops include cotton, lettuce, soybeans, rice, carrots, tomatoes, corn, broccoli, cabbage, potatoes, wheat, or any other suitable commercial crop. The weeds may be grasses, broadleaf weeds, thistles, or any other suitable determinantal weed.

More generally, plants 104 may include a stem that is arranged superior to (e.g., above) the substrate 106 and a root system joined to the stem that is located inferior to the plane of the substrate 106 (e.g., below ground). The stem may support any branches, leaves, and/or fruits. The plant 104 can have a single stem, leaf, or fruit, multiple stems, leaves, or fruits, or any number of stems, leaves or fruits. The root system may be a tap root system or fibrous root system, and the root system may support the plant 104 position and absorb nutrients and water from the substrate 106. In various examples, the plant 104 may be a vascular plant 104, non-vascular plant 104, ligneous plant 104, herbaceous plant 104, or be any suitable type of plant 104.

Plants 104 in a field 160 may be grown in one or more plant 104 rows (e.g., plant 104 beds). The plant 104 rows are typically parallel to one another but do not have to be. Each plant 104 row is generally spaced between 2 inches and 45 inches apart when measured in a perpendicular direction from an axis representing the plant 104 row. Plant 104 rows can have wider or narrower spacings or could have variable spacing between multiple rows (e.g., a spacing of 12 in. between a first and a second row, a spacing of 16 in. a second and a third row, etc.).

Plants 104 within a field 160 may include the same type of crop (e.g., same genus, same species, etc.). For example, each field portion in a field 160 may include corn crops. However, the plants 104 within each field 160 may also include multiple crops (e.g., a first, a second crop, etc.). For example, some field portions may include lettuce crops while other field portions include pig weeds, or, in another example, some field portions may include beans while other field portions include corn. Additionally, a single field portion may include different types of crop. For example, a single field portion may include a soybean plant 104 and a grass weed.

The operating environment 102 may also include a substrate 106. As such, farming actions the farming machine 100 implements as part of a treatment plan may be applied to the substrate 106. The substrate 106 may be soil but can alternatively be a sponge or any other suitable substrate 106. The substrate 106 may include plants 104 or may not include plants 104 depending on its location in the field 160. For example, a portion of the substrate 106 may include a row of crops, while another portion of the substrate 106 between crop rows includes no plants 104.

### III.A Example Machine Configurations

### Detection Mechanism(s)

The farming machine 100 may include a detection mechanism 110. The detection mechanism 110 identifies objects in the operating environment 102 of the farming machine 100. To do so, the detection mechanism 110 obtains information describing the environment 102 (e.g., sensor or image data), and processes that information to identify pertinent objects (e.g., plants 104, substrate 106, persons, etc.) in the operating environment 102. Identifying objects in the environment 102 further enables the farming machine 100 to implement farming actions in the field 160. For example, the detection mechanism 110 may capture an image of the field 160 and process the image with a plant treatment model that identifies plants 104 in the captured image. A plant treatment model may also determine farming actions to implement. The farming machine 100 then implements farming actions in the field 160 based on the output of the plant treatment model.

The farming machine 100 can include any number or type of detection mechanism 110 that may aid in determining and implementing farming actions. In some embodiments, the detection mechanism 110 includes one or more sensors. For example, the detection mechanism 110 can include a multispectral camera, a stereo camera, a CCD camera, a single lens camera, a CMOS camera, hyperspectral imaging system, LIDAR system (light detection and ranging system), a depth sensing system, dynamometer, IR camera, thermal camera, humidity sensor, light sensor, temperature sensor, or any other suitable sensor. Further, the detection mechanism 110 may include an array of sensors (e.g., an array of cameras) configured to capture information about the environment 102 surrounding the farming machine 100. For example, the detection mechanism 110 may include an array of cameras configured to capture an array of pictures representing the environment 102 surrounding the farming machine 100. The detection mechanism 110 may also be a sensor that measures a state of the farming machine 100. For example, the detection mechanism 110 may be a speed sensor, a heat sensor, or some other sensor that can monitor the state of a component of the farming machine 100. Additionally, the detection mechanism 110 may also be a sensor that measures components during implementation of a farming action. For example, the detection mechanism 110 may be a flow rate monitor, a grain harvesting sensor, a mechanical stress sensor etc. Whatever the case, the detection mechanism 110 senses information about the operating environment 102 (including the farming machine 100).

A detection mechanism 110 may be mounted at any point on the mounting mechanism 140. Depending on where the detection mechanism 110 is mounted relative to the treatment mechanism 120, one or the other may pass over a geographic area in the field 160 before the other. For example, the detection mechanism 110 may be positioned on the mounting mechanism 140 such that it traverses over a geographic location before the treatment mechanism 120 as the farming machine 100 moves through the field 160. In another examples, the detection mechanism 110 is positioned to the mounting mechanism 140 such that the two traverse over a geographic location at substantially the same time as the farming machine 100 moves through the filed. Similarly, the detection mechanism 110 may be positioned on the mounting mechanism 140 such that the treatment mechanism 120 traverses over a geographic location before the detection mechanism 110 as the farming machine 100 moves through the field 160. The detection mechanism 110 may be statically mounted to the mounting mechanism 140, or may be removably or dynamically coupled to the mounting mechanism 140. In other examples, the detection mechanism 110 may be mounted to some other surface of the farming machine 100 or may be incorporated into another component of the farming machine 100.

### Verification Mechanism(s)

The farming machine 100 may include a verification mechanism 150. Generally, the verification mechanism 150 records a measurement of the operating environment 102 and the farming machine 100 may use the recorded measurement to verify or determine the extent of an implemented farming action (i.e., a result of the farming action).

To illustrate, consider an example where a farming machine 100 implements a farming action based on a measurement of the operating environment 102 by the detection mechanism 110. The verification mechanism 150 records a measurement of the same geographic area measured by the detection mechanism 110 and where farming machine 100 implemented the determined farming action. The farming machine 100 then processes the recorded measurement to determine the result of the farming action. For example, the verification mechanism 150 may record an image of the geographic region surrounding a plant 104 identified by the detection mechanism 110 and treated by a treatment mechanism 120. The farming machine 100 may apply a treatment detection algorithm to the recorded image to determine the result of the treatment applied to the plant 104.

Information recorded by the verification mechanism 150 can also be used to empirically determine operation parameters of the farming machine 100 that will obtain the desired effects of implemented farming actions (e.g., to calibrate the farming machine 100, to modify treatment plans, etc.). For instance, the farming machine 100 may apply a calibration detection algorithm to a measurement recorded by the farming machine 100. In this case, the farming machine 100 determines whether the actual effects of an implemented farming action are the same as its intended effects. If the effects of the implemented farming action are different than its intended effects, the farming machine 100 may perform a calibration process. The calibration process changes operation parameters of the farming machine 100 such that effects of future implemented farming actions are the same as their intended effects. To illustrate, consider the previous example where the farming machine 100 recorded an image of a treated plant 104. There, the farming machine 100 may apply a calibration algorithm to the recorded image to determine whether the treatment is appropriately calibrated (e.g., at its intended location in the operating environment 102). If the farming machine 100 determines that the farming machine 100 is not calibrated (e.g., the applied treatment is at an incorrect location), the farming machine 100 may calibrate itself such that future treatments are in the correct location. Other example calibrations are also possible.

The verification mechanism 150 can have various configurations. For example, the verification mechanism 150 can be substantially similar (e.g., be the same type of mechanism as) the detection mechanism 110 or can be different from the detection mechanism 110. In some cases, the detection mechanism 110 and the verification mechanism 150 may be one in the same (e.g., the same sensor). In an example configuration, the verification mechanism 150 is positioned distal the detection mechanism 110 relative the direction of travel 115, and the treatment mechanism 120 is positioned there between. In this configuration, the verification mechanism 150 traverses over a geographic location in the operating environment 102 after the treatment mechanism 120 and the detection mechanism 110. However, the mounting mechanism 140 can retain the relative positions of the system components in any other suitable configuration. In some configurations, the verification mechanism 150 can be included in other components of the farming machine 100.

The farming machine 100 can include any number or type of verification mechanism 150. In some embodiments, the verification mechanism 150 includes one or more sensors. For example, the verification mechanism 150 can include a multispectral camera, a stereo camera, a CCD camera, a single lens camera, a CMOS camera, hyperspectral imaging system, LIDAR system (light detection and ranging system), a depth sensing system, dynamometer, IR camera, thermal camera, humidity sensor, light sensor, temperature sensor, or any other suitable sensor. Further, the verification mechanism 150 may include an array of sensors (e.g., an array of cameras) configured to capture information about the environment 102 surrounding the farming machine 100. For example, the verification mechanism 150 may include an array of cameras configured to capture an array of pictures representing the operating environment 102.

### Treatment Mechanism(s)

The farming machine 100 may include a treatment mechanism 120. The treatment mechanism 120 can implement farming actions in the operating environment 102 of a farming machine 100. For instance, a farming machine 100 may include a treatment mechanism 120 that applies a treatment to a plant 104, a substrate 106, or some other object in the operating environment 102. More generally, the farming machine 100 employs the treatment mechanism 120 to apply a treatment to a treatment area 122, and the treatment area 122 may include anything within the operating environment 102 (e.g., a plant 104 or the substrate 106). In other words, the treatment area 122 may be any portion of the operating environment 102.

When the treatment is a plant treatment, the treatment mechanism 120 applies a treatment to a plant 104 in the field 160. The treatment mechanism 120 may apply treatments to identified plants or non-identified plants. For example, the farming machine 100 may identify and treat a specific plant (e.g., plant 104) in the field 160. Alternatively, or additionally, the farming machine 100 may identify some other trigger that indicates a plant treatment and the treatment mechanism 120 may apply a plant treatment. Some example plant treatment mechanisms 120 include: one or more spray nozzles, one or more electromagnetic energy sources (e.g., a laser), one or more physical implements configured to manipulate plants, one or more vibrational energy sources, but other plant 104 treatment mechanisms 120 are also possible.

Additionally, when the treatment is a plant treatment, the effect of treating a plant 104 with a treatment mechanism 120 may include any of plant necrosis, plant growth stimulation, plant portion necrosis or removal, plant portion growth stimulation, or any other suitable treatment effect. Moreover, the treatment mechanism 120 can apply a treatment that dislodges a plant 104 from the substrate 106, severs a plant 104 or portion of a plant 104 (e.g., cutting), incinerates a plant 104 or portion of a plant 104, electrically stimulates a plant 104 or portion of a plant 104, fertilizes or promotes growth (e.g., with a growth hormone) of a plant 104, waters a plant 104, applies light or some other radiation to a plant 104, and/or injects one or more working fluids into the substrate 106 adjacent to a plant 104 (e.g., within a threshold distance from the plant). Other plant treatments are also possible. When applying a plant treatment, the treatment mechanisms 120 may be configured to spray a treatment product such as one or more of: an herbicide, a fungicide, insecticide, some other pesticide, or water.

When the treatment is a substrate treatment, the treatment mechanism 120 applies a treatment to some portion of the substrate 106 in the field 160. The treatment mechanism 120 may apply treatments to identified areas of the substrate 106, or non-identified areas of the substrate 106. For example, the farming machine 100 may identify and treat an area of substrate 106 in the field 160. Alternatively, or additionally, the farming machine 100 may identify some other trigger that indicates a substrate 106 treatment and the treatment mechanism 120 may apply a treatment to the substrate 106. Some example treatment mechanisms 120 configured for applying treatments to the substrate 106 include: one or more spray nozzles, one or more electromagnetic energy sources, one or more physical implements configured to manipulate the substrate 106, but other substrate 106 treatment mechanisms 120 are also possible.

Of course, the farming machine 100 is not limited to treatment mechanisms 120 for plants 104 and substrates 106. The farming machine 100 may include treatment mechanisms 120 for applying various other treatments to objects in the field 160. Depending on the configuration, the farming machine 100 may include various numbers of treatment mechanisms 120 (e.g., 1, 2, 5, 20, 60, etc.). A treatment mechanism 120 may be fixed (e.g., statically coupled) to the mounting mechanism 140 or attached to the farming machine 100. Alternatively, or additionally, a treatment mechanism 120 may movable (e.g., translatable, rotatable, etc.) on the farming machine 100. In one configuration, the farming machine 100 includes a single treatment mechanism 120. In this case, the treatment mechanism 120 may be actuatable to align the treatment mechanism 120 to a treatment area 122. In a second variation, the farming machine 100 includes a treatment mechanism 120 assembly comprising an array of treatment mechanisms 120. In this configuration, a treatment mechanism 120 may be a single treatment mechanism 120, a combination of treatment mechanisms 120, or the treatment mechanism 120 assembly. Thus, either a single treatment mechanism 120, a combination of treatment mechanisms 120, or the entire assembly may be selected to apply a treatment to a treatment area 122. Similarly, either the single, combination, or entire assembly may be actuated to align with a treatment area, as needed. In some configurations, the farming machine 100 may align a treatment mechanism 120 with an identified object in the operating environment 102. That is, the farming machine 100 may identify an object in the operating environment 102 and actuate the treatment mechanism 120 such that its treatment area aligns with the identified object.

A treatment mechanism 120 may be operable between a standby mode and a treatment mode. In the standby mode the treatment mechanism 120 does not apply a treatment, and in the treatment mode the treatment mechanism 120 is controlled by the control system 130 to apply the treatment. However, the treatment mechanism 120 can be operable in any other suitable number of operation modes.

### Control System(s)

The farming machine 100 includes a control system 130. The control system 130 controls operation of the various components and systems on the farming machine 100. For instance, the control system 130 can obtain information about the operating environment 102, processes that information to identify a farming action to implement (e.g., via a plant treatment model), and implement the identified farming action with system components of the farming machine 100.

The control system 130 can receive information from the detection mechanism 110, the verification mechanism 150, the treatment mechanism 120, and/or any other component or system of the farming machine 100. For example, the control system 130 may receive measurements from the detection mechanism 110 or verification mechanism 150, or information relating to the state of a treatment mechanism 120 or implemented farming actions from a verification mechanism 150. Other information is also possible.

Similarly, the control system 130 can provide input to the detection mechanism 110, the verification mechanism 150, and/or the treatment mechanism 120. For instance, the control system 130 may be configured input and control operating parameters of the farming machine 100 (e.g., speed, direction). Similarly, the control system 130 may be configured to input and control operating parameters of the detection mechanism 110 and/or verification mechanism 150. Operating parameters of the detection mechanism 110 and/or verification mechanism 150 may include processing time, location and/or angle of the detection mechanism 110, image capture intervals, image capture settings, etc. Other inputs are also possible. Finally, the control system may be configured to generate machine inputs for the treatment mechanism 120. That is, translating a farming action of a treatment plan into machine instructions implementable by the treatment mechanism 120.

The control system 130 can be operated by a user operating the farming machine 100, wholly or partially autonomously, operated by a user connected to the farming machine 100 by a network, or any combination of the above. For instance, the control system 130 may be operated by an agricultural manager sitting in a cabin of the farming machine 100, or the control system 130 may be operated by an agricultural manager connected to the control system 130 via a wireless network. In another example, the control system 130 may implement an array of control algorithms, machine vision algorithms, decision algorithms, etc. that allow it to operate autonomously or partially autonomously.

The control system 130 may be implemented by a computer or a system of distributed computers. The computers may be connected in various network environments. For example, the control system 130 may be a series of computers implemented on the farming machine 100 and connected by a local area network. In another example, the control system 130 may be a series of computers implemented on the farming machine 100, in the cloud, a client device and connected by a wireless area network.

The control system 130 can apply one or more computer models to determine and implement farming actions in the field 160. For example, the control system 130 can apply a plant treatment model to images acquired by the detection mechanism 110 to determine and implement farming actions. The control system 130 may be coupled to the farming machine 100 such that an operator (e.g., a driver) can interact with the control system 130. In other embodiments, the control system 130 is physically removed from the farming machine 100 and communicates with system components (e.g., detection mechanism 110, treatment mechanism 120, etc.) wirelessly.

In some configurations, the farming machine 100 may additionally include a communication apparatus, which functions to communicate (e.g., send and/or receive) data between the control system 130 and a set of remote devices. The communication apparatus can be a Wi-Fi communication system, a cellular communication system, a short-range communication system (e.g., Bluetooth, NFC, etc.), or any other suitable communication system.

### Other Machine Components

In various configurations, the farming machine 100 may include any number of additional components.

For instance, the farming machine 100 may include a mounting mechanism 140. The mounting mechanism 140 provides a mounting point for the components of the farming machine 100. That is, the mounting mechanism 140 may be a chassis or frame to which components of the farming machine 100 may be attached but could alternatively be any other suitable mounting mechanism 140. More generally, the mounting mechanism 140 statically retains and mechanically supports the positions of the detection mechanism 110, the treatment mechanism 120, and the verification mechanism 150. In an example configuration, the mounting mechanism 140 extends outward from a body of the farming machine 100 such that the mounting mechanism 140 is approximately perpendicular to the direction of travel 115. In some configurations, the mounting mechanism 140 may include an array of treatment mechanisms 120 positioned laterally along the mounting mechanism 140. In some configurations, the farming machine 100 may not include a mounting mechanism 140, the mounting mechanism 140 may be alternatively positioned, or the mounting mechanism 140 may be incorporated into any other component of the farming machine 100.

The farming machine 100 may include locomoting mechanisms. The locomoting mechanisms may include any number of wheels, continuous treads, articulating legs, or some other locomoting mechanism(s). For instance, the farming machine 100 may include a first set and a second set of coaxial wheels, or a first set and a second set of continuous treads. In the either example, the rotational axis of the first and second set of wheels/treads are approximately parallel. Further, each set is arranged along opposing sides of the farming machine 100. Typically, the locomoting mechanisms are attached to a drive mechanism that causes the locomoting mechanisms to translate the farming machine 100 through the operating environment 102. For instance, the farming machine 100 may include a drive train for rotating wheels or treads. In different configurations, the farming machine 100 may include any other suitable number or combination of locomoting mechanisms and drive mechanisms.

The farming machine 100 may also include one or more coupling mechanisms 142 (e.g., a hitch). The coupling mechanism 142 functions to removably or statically couple various components of the farming machine 100. For example, a coupling mechanism may attach a drive mechanism to a secondary component such that the secondary component is pulled behind the farming machine 100. In another example, a coupling mechanism may couple one or more treatment mechanisms 120 to the farming machine 100.

The farming machine 100 may additionally include a power source, which functions to power the system components, including the detection mechanism 110, control system 130, and treatment mechanism 120. The power source can be mounted to the mounting mechanism 140, can be removably coupled to the mounting mechanism 140, or can be incorporated into another system component (e.g., located on the drive mechanism). The power source can be a rechargeable power source (e.g., a set of rechargeable batteries), an energy harvesting power source (e.g., a solar system), a fuel consuming power source (e.g., a set of fuel cells or an internal combustion system), or any other suitable power source. In other configurations, the power source can be incorporated into any other component of the farming machine 100.

### III.B System Environment

FIG. 2 is a block diagram of the system environment for the farming machine 100, in accordance with one or more example embodiments. In this example, the control system 210 (e.g., control system 130) is connected to external systems 220, a machine component array 230, and a client device 242 via a network 240 within the system environment 200.

The external systems 220 are any system that can generate data representing information useful for determining and implementing farming actions in a field. External systems 220 may include one or more sensors 222, one or more processing units 224, and one or more datastores 226. The one or more sensors 222 can measure the field 160, the operating environment 102, the farming machine 100, etc. and generate data representing those measurements. For instance, the sensors 222 may include a rainfall sensor, a wind sensor, heat sensor, a camera, etc. The processing units may process measured data to provide additional information that may aid in determining and implementing farming actions in the field. For instance, a processing unit 224 may access an image of a field 160 and calculate a weed pressure from the image or may access historical weather information for a field 160 to generate a forecast for the field. Datastores 226 store historical information regarding the farming machine 100, the operating environment 102, the field 160, etc. that may be beneficial in determining and implementing farming actions in the field. For instance, the datastore 226 may store results of previously implemented treatment plans and farming actions for a field 160, a nearby field, and or the region. The historical information may have been obtained from one or more farming machines (i.e., measuring the result of a farming action from a first farming machine with the sensors of a second farming machine). Further, the datastore 226 may store results of specific faming actions in the field 160, or results of farming actions taken in nearby fields having similar characteristics. The datastore 226 may also store historical weather, flooding, field use, planted crops, etc. for the field and the surrounding area. Finally, the datastores 226 may store any information measured by other components in the system environment 200.

The machine component array 230 includes one or more components 232. Components 232 are elements of the farming machine 100 that can take farming actions (e.g., a treatment mechanism 120). As illustrated, each component has one or more input controllers 234 and one or more sensors 236, but a component may include only sensors 236 or only input controllers 234. An input controller 234 controls the function of the component 232. For example, an input controller 234 may receive machine commands via the network 240 and actuate the component 232 in response. A sensor 236 generates data representing measurements of the operating environment 102 and provides that data to other systems and components within the system environment 200. The measurements may be of a component 232, the farming machine 100, the operating environment 102, etc. For example, a sensor 236 may measure a configuration or state of the component 232 (e.g., a setting, parameter, power load, etc.), measure conditions in the operating environment 102 (e.g., moisture, temperature, etc.), capture information representing the operating environment 102 (e.g., images, depth information, distance information), and generate data representing the measurement(s).

The control system 210 receives information from external systems 220, the machine component array 230, and/or the client device 242 and implements a treatment plan in a field with a farming machine. The control system 210 includes an insight miner 212 and a training module 214 but may include additional or fewer modules. Moreover, the functionality of the various modules may be different than described herein, and/or may be provided by different elements in the system environment 200. At a high level, in implementing the treatment plan, the control system 210 may insight miner 212 to determine farming actions to perform in the field based on insights identified in time-series agronomy information, and may use the training module 214 to train the insight minder 212. The control system 210 and its constituent modules are described in greater detail below.

The client device 242 is one or more computing devices capable of receiving user input as well as transmitting and/or receiving data via the network 240. In one embodiment, a client device 242 is a conventional computer system, such as a desktop or a laptop computer. Alternatively, a client device 242 may be a device having computer functionality, such as a personal digital assistant (PDA), a mobile telephone, a smartphone, or another suitable device. A client device 242 is configured to communicate via the network 240. In one embodiment, a client device 242 executes an application allowing a user of the client device 242 to interact with the control system 210. For example, a client device 242 executes a browser application to enable interaction between the client device 242 and the control system 210 via the network 240. In another embodiment, a client device 242 interacts with the control system 210 through an application programming interface (API) running on a native operating system of the client device 242, such as IOS® or ANDROID™ The client device 242 may be used to interact with a farming machine 100 implementing a treatment plan in a field.

The network 250 connects nodes of the system environment 200 to allow microcontrollers and devices to communicate with each other. In some embodiments, the components are connected within the network as a Controller Area Network (CAN). In this case, within the network each element has an input and output connection, and the network 250 can translate information between the various elements. For example, the network 250 receives input information from the external systems 220 array and component array 230, processes the information, and transmits the information to the control system 210. The control system 210 generates a farming action based on the information and transmits instructions to implement the farming action to the appropriate component(s) 232 of the component array 230.

Additionally, the system environment 200 may be other types of network environments and include other networks, or a combination of network environments with several networks. For example, the system environment 200, can be a network such as the Internet, a LAN, a MAN, a WAN, a mobile wired or wireless network, a private network, a virtual private network, a direct communication line, and the like. In some embodiments, the network 240 may comprise any combination of local area and/or wide area networks, using both wired and/or wireless communication systems. In one embodiment, the network 240 uses standard communications technologies and/or protocols.

### IV. Identifying Agricultural Insights Using an Insight Miner

As described above, using a computer model to generate insights about time-series data is challenging for a variety of reasons. However, efficiently and quickly leveraging that vast amount of time-series data available to agronomists and acquired by agricultural machines to generate insights for farming actions in the field would be useful. As such, the control system 210 of the farming machine 100 includes an insight miner 212 and a training module 214 for the insight miner. As described in greater detail below, the insight miner 212 inputs time-series information about agricultural events and/or agricultural measurements in the field and outputs insights about that information. In some configurations, the insight miner 212 determines one or more farming actions to perform in the field based on those insights, and the farming machine may implement the farming action(s).

At a high level, the insight miner 212 includes three stages: (1) an ingestion stage, (2) a trend identification stage (e.g., an insight), and (3) an action identification stage.

In the ingestion stage, the insight miner 212 inputs or accesses agricultural information. The agricultural information may be, e.g., a history of farming actions taken in a field accessed from an external datastore 226, current and previous environment measurements accessed from external sensors 222 and external datastores 226, measurements from sensors 236 from the machine component array 230, agronomic conditions, histories, and preferences for a region containing the field received from a client device 242, previous harvest, yield, or profit measurements accessed from an external datastore 226, etc.

Generally, the accessed agricultural information is time-series information. That is, the time-series information includes data describing some relevant agronomic characteristic, measurement, practice, etc. over time. So, for instance, the time-series information may give the temperature every hour in a growing season, the yields of a field every season, the nitrogen levels in the soil every month of the year, etc. Of course, various latent information may exist in this time-series information and/or the combination of time-series information. For instance, using a granular example, there may be latent information indicating that the nitrogen levels in the soil are increasing over time. Or, using a broader example, there may be latent information in the data that links the weather and soil time-series information to the yield of that field over the same period. The insight miner 212, as described below, is configured to identify the various trends and correlations in the time-series data and use that information to inform agronomic decisions.

Additionally, in some configurations, the accessed agricultural information may include spatiotemporal information. That is, the time-series data may also be linked to position information such that insights may be garnered based on both the “where” and “when” information latent in the data. For instance, using the above example, there may be latent information indicating that the nitrogen levels in the soil of a particular area of the field are increasing, while nitrogen levels in the soil for a different area of the field may be decreasing. Or, again expanding the broader example above, there may be latent information in the data that links the weather and soil time-series information to the yield in various field portions over time. The insight miner 212, as described below, is configured to identify the various trends and correlations in the spatiotemporal data and use that information to inform agronomic decisions.

In various examples, the insight miner may 212 apply one or more pre-processing functions to the time-series data. For example, the insight miner may add noise, scale (e.g., multiply data values by a constant), shift (e.g., add a constant to data values), smooth (e.g., convolution, etc.), down-sample (e.g., interpolating fewer time-series data points, up-sample (e.g., interpolate additional time-series data points), etc. the time-series data. Each function may serve different purposes. For example, smoothing data may be used for sensor data known to have malfunctions and produce “jittery” data, or down sampling data may be used to create daily data from hourly data. Many examples are possible.

The insight miner 212 may create one or more time window(s) for the input agricultural information and select data from the agricultural information that adheres to that time window. For instance, the insight miner 212 may create a time window reflecting a most recent growing season of a field and populate that time window with the time-series data corresponding to that growing season. Other examples are also possible. Additionally, a time window can be any length of time appropriate to the various use cases. For instance, a time window can be an hour, a day, a month, years, a season, multiple seasons, etc. Moreover, the insight miner may create time windows that encompass all the data, or only some of the data. For instance, consider time-series information that includes data points for every day in the year. The insight miner 212 may create time windows representing each month of the year and bin the data accordingly, or it may create a time window representing summer and bin only summer data into that time window (while ignoring the rest).

The insight miner 212 generates a visual representation of the agricultural information. For example, the insight miner may create an x-y plot representing the time-series information. Thus, the x axis represents the time while the y axis represents, e.g., a measurement or a farming action. In various configurations, the axes on the plot may be labelled or unlabeled, and/or the trendlines on the plot may be labelled or unlabeled. Each visual representation may include a single type of time-series information or may include multiple types of time-series information. For instance, the visual representation may include only the time-series information for nitrogen in the soil, or it may include the time-series information for both nitrogen in the soil and yield.

Additionally, the insight miner 212 may generate one or more visual representations of the time-series information depending on the circumstances. For instance, the insight miner 212 may create a visual representation for each month in a year or may create a visual representation of the entire year. In other words, the insight miner 212 may generate visual representations corresponding to any time window.

At the trend identification stage, the insight miner inputs the one or more visual representations into an insight recognition model (“insight model”). The insight model outputs a natural language response describing the time-series information as a response. The natural language response provides a natural language, easy to understand, qualitative description of the time-series information. For example, the natural language response may be, “The soil nitrogen generally increases, levels, then abruptly decreases,” or may be “the yield is trending downwards over the past twenty-five years, but includes occasional yield spikes.”

The configuration of the insight model can take various forms. In an example, the insight model is a large-scale multi-modal model configured for analyzing time-series information but could be another. To provide a contextual example, the insight model may be a Large Language and Vision Assistant model (“LLaVA”), a Generative Pre-Trained Transformer (“GPT”), etc.

To that end, the insight model can have different model structures. Typically, though, the insight model includes a linear projection layer. The linear projection layer maps a visual representation to a language embedding space. Thus, the linear project layer inputs a visual representation of time-series data and creates a language-based embedding representing that visual representation. Additional layers in the model may include typical layers for encoding visual information and processing natural language.

Given this structure, layers of the insight model input (e.g., language layers) input the language-based embedding of the visual representation of the time-series data concatenated with natural language instructions and provides a natural language response describing that time-series information. More simply, a user may instruct the insight miner 212 to “Describe the nitrogen levels in the soil for the past five months,” and the insight miner may reply “The soil nitrogen generally reduced over three months to a stable level over the past two month.”

The insight miner 212 may obtain and access information relevant agricultural information to the user request for information. That is, the insight miner may input and process a natural language request for an insight regarding time-series agricultural information, identify the sources of that time-series information, and obtain the time-series information as needed. For example, the operator of the farming machine may ask the insight miner, “What is the temperature of the engine over the past two hours?” and the insight miner may access the relevant sensor information to generate the insight.

At the action identification stage, the insight miner 212 identifies farming actions to perform in the field and causes the farming machine 100 to execute those actions. As a simple example, the insight miner 212 may identify that the nitrogen levels in the field are decreasing and subsequently cause the farming machine to apply nitrogen fertilizer to the field. In another example, the insight miner 212 may identify that the weed density in the field is increasing and subsequently cause the farming machine to perform plant identification and removal actions.

Identifying farming actions to take in the field based on natural language responses describing the time-series information can take a myriad of forms.

For instance, in an example, the control system 210 may receive a request for an insight about agronomic information, apply the insight miner 212 to the time-series information to generate the insight (e.g., a natural language response describing the agronomic information), and provide the insight to the requestor. The requestor may then provide a farming action to take in the field based on the (e.g., from an operator of the farming machine, a manager of the field, etc.). Depending on the circumstances, the requestor may be, e.g., an operator of the farming machine, a manager of the field, etc. Moreover, the requestor may generate the request locally at the farming machine 100 or remotely via, e.g., a client device 242.

In an example, to identify a farming action based on the insight, the farming machine may apply an action identification model to the insight. The action identification model may be, e.g., a large language model, a decision tree, a classifier, etc. Moreover, the action identification model may also input agronomic information relevant to identifying the appropriate farming action. For instance, the action identification model may input current sensor measurements or state information of the farming machine concatenated with the insight and generate a farming action based on the same.

To provide a contextual example, the insight miner 212 may identify that the weed density in an area of a field is increasing. The action identification model inputs the insight, state information of the farming machine describing its position, speed, configuration, etc., and images of the operating environment of the farming machine. In this case, the insight miner 212 identifies applying herbicides to weeds as a farming action to take in the field. It may do so because the insight indicates weed density is increasing, the state information indicates the farming machine is configured for regulating plant growth, and weeds are visible in the operating environment.

In an example, farming actions to implement are linked to specific insights generated by the insight miner 212. That is, if the insight miner 212 identifies a certain trend for a certain type of agronomic information, the insight miner 212 may access a farming action defined for that trend and perform that farming action in the field. For example, the farming machine may be configured to halt operation and return to safety if an insight related to impending severe inclement weather is identified.

To provide a specific example the insight miner 212 may gather time-series information describing plant height, generate an insight based on that information, and perform a farming action based on the insight. For example, a farming machine may gather time-series representations of plant height by taking measurements during repeated visits to the field. The farming machine may do so by applying, e.g., an identification model to images captured by the farming machine, and the identification model determines which pixels represent a plant (e.g., crop or weed), the substrate, etc., and determines the height of the identified plants. Plant height and spectral measurements of vegetation (e.g., NDVI) provide an indicator of biomass. Thus, the farming machine can generate a time-series representation of plant biomass by repeated measurement in the field.

The insight miner 212 processes this time-series biomass data to identify an insight (e.g., trend) and determine a farming action based on that trend. For example, by taking the difference in height or biomass between adjacent temporal collections, the insight miner 212 can compute the growth rate (change in height vs time) of plants in the field. Given this information, the insight miner can predict when the field will be ready for harvest or derive insight into whether the field is “ahead” or “behind” where it would be expected to be at a certain point in the season. For instance, using cotton plants as an example, the insight miner 212 can input an insight describing a growth rate for the plants and an expected weather forecast for the next 10 days and output a farming action to apply plant growth regulator and how much should be applied. Application of PGR will typically slow down the growth rate of the plants so they can be harvested at a height that is optimized for the cotton harvester.

Accordingly, if the insight miner 212 determines the growth rate is “ahead” of typical based on the time-series data, and the and the weather prediction is for 10 days of hot, dry weather, the insight miner 212 may determine to apply a higher rate of PGR to slow down the growth, anticipating a lot of growth during the hot spell. Conversely if the growth rate is measured to be high, but the next 10 days are going to be cold and rainy, a typical farming decision would be to apply a lower rate of PGR, anticipating less growth during the cold wet spell. In this fashion the insight miner 212 can take time series data and merge it with other types of information (e.g. weather) to make recommendations on farming actions. In some cases, farming actions determined by the insight miner 212 may manifest as a prescription map of farming action. The prescription map is a spatial map of the field that contains farming actions (e.g., rate instructions) based on various input information (e.g., computed from the height, biomass, and weather layers). The prescription map can be loaded onto the sprayer and then the sprayer will apply the chemical according to the instructions in the prescription map.

Notably, in any of the above examples, the one or more actions identified in the action determination stage may be based on more than one insight, and the determined farming action may be based on those input insights. For example, an action identification model may input an insight for weather data and an insight for soil moisture data. For instance, the former may include that “the weather over the previous ten summers includes a stable, low level of rainfall,” while the latter may include that “the soil moisture is decreasing steadily over the past month.” In turn, the insight miner 212 may determine one or more farming actions to artificially increase the soil moisture given the likelihood of low rainfall.

Of course, these are just illustrative examples and there are many ways to identify relevant farming actions to perform in the field based on insights generated by the insight miner 212.

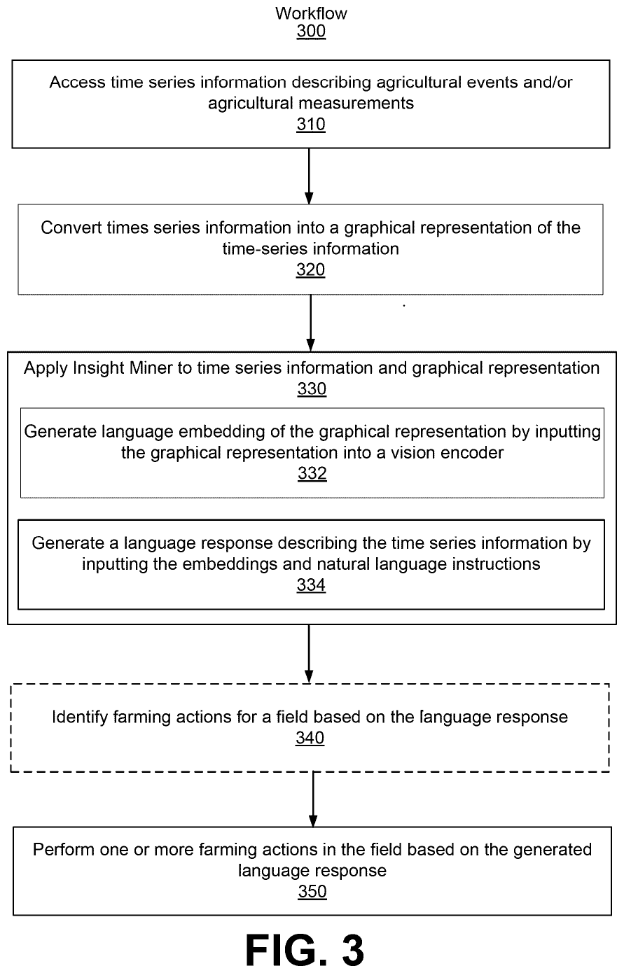

To demonstrate treatment of plants based on insights from an insight miner, FIG. 3 illustrates a workflow for performing one or more farming actions in a field, in accordance with one or more example embodiments. The workflow 300 may include additional or fewer steps, and the steps may occur in a different order. One or more of the stops may be repeated or omitted depending on the circumstances.

In this example, a farming machine (e.g., farming machine 100) is operating in a field (e.g., field 160). The farming machine may operate autonomously or semi-autonomously and the field is managed by a manager. Thus, the manager uses a client device (e.g., client device 242) to provide instructions for the farming machine. For instance, the manager may instruct the farming machine to perform various farming actions in the field based on agricultural information. The information may be about the field, farming machine, environment, etc. The manager or the farming machine may receive or access information via the client device.

Here, the farming machine includes an insight miner (e.g., insight miner 212). The insight miner is configured to receive natural language instructions, access agricultural information relevant to those instructions, and generate insights (e.g., natural language descriptions) about the accessed agricultural information. The agricultural information may be, e.g., time-series information describing agricultural actions (e.g., planting, tilling, watering, etc.), agricultural measurements (e.g., yield, pressure, speed, position, etc.), etc., In some cases, the insight miner may identify and implement farming actions based on the determined insight.

To expand, the manager generates natural language instructions for the farming machine to provide an insight regarding agricultural information and transmits the instructions to the farming machine. An a contextual example, the manager desires to use an autonomous farming machine configured to treat plants to spray a cotton field with 30″ rows with dicamba (a herbicide). The farm manager might say: “Ok Farming Machine, set up my system to spray Dicamba on 30″ rows with a canopy height of 24, using the TSL80 nozzle tip.”. The insight miner farming machine (e.g., the insight miner 212) parses the instructions and generates machine instructions to set up the farming machine in the desired configuration, saving the user from having to select multiple options on the in-cab display.

The farming machine receives the natural language instructions and accesses 310 the agricultural information relevant to those natural language instructions. The agricultural information comprises time-series information describing agricultural events (e.g., farming actions) and/or agricultural measurements.

The farming machine generates 320 a visual representation of the agricultural information. For example, the visual representation may be a graphical representation of the time-series information. The time-series information may be that information in a time window rather than all the time-series information.

The farming machine applies 330 an insight identification model to the visual representation to generate a language response describing the agricultural information. The insight model inputs the visual representation into a vision encoder. The vision encoder maps the visual representation to a language embedding space. As a result, the vision encoder generates 332 a language embedding of the visual representation of the agricultural information. The insight model inputs the language embedding and the natural language instruction into a language model. The language model, based on the embedding and the natural language instruction, generates 334 a language response describing the agricultural information represented in the visual representation.

The farming machine identifies one or more farming actions to perform in the field based on the language response, and the farming machine performs 340 the one or more farming actions. Identifying the one or more farming actions may include one or more of, requesting the actions from the manager, applying a model to the insight, or performing actions associated with the insight.

Notably, while the example above is framed as the farming machine accessing information and applying the insight model to determine farming actions, that may occur on the client device of the manager (or some other connected system).

### V. Training the Insight Miner

The control system 210 also includes a training module 214. The training module is configured to both generate datasets to train an insight miner and train the insight miner with those datasets. Notably, while illustrated on the control system 210, the training module may reside on a client device 242 or an external system 220. In this manner, the insight miner 212 may be trained and configured on a system remote from the farming machine 100. The trained insight miner 212 may be transmitted to the farming machine 100 where it is executed locally as the farming machine 100 travels through the field.

To train the insight miner 212, the training module first generates datasets that pairs time-series data and language description of that time-series data (“time-series pairs”) for general time-series analysis. Generating time-series pairs is described hereinbelow.

Formally, the training module 214 begins with N time-series datasets {Dᵢ}ᵢ^{N=}1. Each dataset Dᵢ has Tᵢ, total time steps and Mᵢ features. E.g., Dᵢ={Xⱼ}ⱼ₌₁^{T}^{ᵢ} and Xⱼϵ [symbol] ^{M}^{ᵢ}. Within this formulism, the training module generates a question-answer pair for each time-series window Wₖϵ [symbol] ^{m}^{ₖ}^{×T}^{ₖ}. The question-answer pair is randomly sampled from the N datasets, where Tₖ represents the number of time steps and mₖ represents the number of features. Both the number of time steps Tₖ and the number of features mₖ are randomly subsampled from the chosen dataset.

The training module 214 creates a single-round instruction for a training sample following:

$$Human : {W}_{k} ∖ n {L}_{k}^{Q} < STOP > ∖ n Assistant : {L}_{k}^{A} < STOP > ∖ n . \qquad ( 1 )$$

where, using (Wₖ, Lₖ^{Q}, Lₖ^{A}), each training sample consists of a time-series window Wₖ, a question Lₖ^{Q}, and an answer Lₖ^{A}.

In traditional systems, generating such datasets for common modalities (e.g., images) includes prompting language-only models such as, e.g., GPT-4. For example, a LLaVA model asks GPT-4 to generate multiturn conversations given the image caption and the bounding boxes of the objects in the image. However, the time-series modality presents unique challenges because (i) there are no original captions available for a time-series window, (ii) existing tools cannot readily convert a time-series segment into an input format that is suitable for language-only GPTs, and (iii) the semantic meanings of time-series windows are more difficult to be described in natural languages.

To address these challenges (especially the third), the training module 214 focuses on a time-series windows containing a single feature, e.g., Wₖϵ [symbol] ^{1×T}^{ₖ}. Following a traditional time-series analysis, the training module 214 generates descriptions based on the trend, the seasonality, and the residuals that are present in the window. A naive solution includes feeding raw time-series data as a vector when prompting a large language model like GPT-4. For example, “Given the time-series [0.52, 0.98, 0.95, 0.91, 1.24, . . . , 1.32], generate a description about its trend, seasonality, and volatility.” However, this approach fails to accurately extract each component from the raw vector. Instead, the training module 214 leverages a statistical Seasonal-Trend Decomposition (STL) model to decompose the original time-series into a trend component, a seasonality component, and a residual component. The training module 214 generates a description only based on one of these components at a time.

To generate the trend description for a given time-series window Wₖϵ [symbol] ^{1×T}^{ₖ}, the training module 214 first applies a STL decomposition to extract the trend

$${W}_{k} = {T}_{k} + {S}_{k} + {R}_{k} , \qquad ( 2 )$$

where Tₖ, Sₖ, and Rₖ denote the extracted trend, seasonality, and residual components, respectively. Denote the value at each individual time step of the extracted trend as Tₖ=(ŷ₁, ŷ₂, . . . , ŷ_{T}_{ₖ}).

In some cases, Wₖ might not have any seasonalities. When this occurs, the training module 214 fits a Gaussian Process (GP) to the Tₖ time steps in the window. For example, given the context above, let Wₖ=(y₁, y₂, . . . , y_{T}_{ₖ}), where yᵢ is the value at each time step. Wₖ is modeled by a standard zero-mean GP, whose covariance structure is defined by a kernel K( . . . ). Here, the kernel used is a combination of a radial basis function (“RBF”) kernel. Using the RBF kernel, the training module 214 models the dependency among different time steps and a white-noise kernel to model the observational noise. That is, Wₖ˜GP(μ(x), K(x, x′)), where

$$μ ( x ) = 0 , K ( x , {x}^{′} ) = R B F ( x , {x}^{′} ) + {σ}_{e}^{2} {δ}_{x , {x}^{′}} , R B F ( x , {x}^{′} ) = {σ}_{r}^{2} exp ( - \frac{{( x , {x}^{′} )}^{2}}{2 γ} )$$

and δ_{x,x}, is the Kronecker delta. The training module 214 estimates parameters σᵣ², l and σₑ² from the data by maximizing the likelihood. The training module 214 computes the fitted mean of the Gaussian Process regression at the respective time steps to get Tₖ=(ŷ₁, ŷ₂, . . . , ŷₖ) as the extracted trend.

The training module 214 applies a Gaussian kernel [symbol] ₖ=[ [symbol] ₁, [symbol] ₂, . . . , [symbol] _{w}_{ₖ}], where wₖ is a hyperparameter for the kernel size, to further smooth out the trend, and followed by downsampling with stride size sₖ:

$${\tilde{y}}_{1} = {\sum }_{j = {w}_{k} / / 2}^{{w}_{k} / / 2} {\hat{y}}_{{s}_{k} \cdot i - j} \cdot {ℱ}_{{w}_{k} / / 2 + j} \qquad ( 3 )$$

for i=1, 2, . . . , Tₖ/sₖ.

Finally, the training module rounds each entry of (\tilde{y}₁, \tilde{y}₂, . . . , \tilde{y}_{T}_{ₖ}/sₖ) to one decimal place and feed it to a large language model (e.g., GPT-4). As such, one data sample pair consists of the original time-series window Wₖ and the trend description generated by the large language model. An overview of the workflow is shown below.

Using the approach above, the training module 214 generates a large number (e.g., 5 k, 10 k, 20 k, etc.) of samples based on a number of datasets (e.g., 10, 15, 20, 30, 50, etc.) from and external system 220 (e.g., a datastore 226 such as Monash Time Series Forecasting Archive). The training module may leave several of the datasets from the external system 220 as holdout sets, which are only used for evaluation but not for training.

Datasets from the external system may span a wide range of domains. For example, the domains may include, e.g., energy, weather, traffic, agronomy, and healthcare. Notably, the training module 214 may only samples windows from the train split of each dataset (e.g., the first 70% of the time steps in temporal order). Some datasets contain multiple levels of seasonalities, e.g., daily and weekly. Under the original granularity, each window might not contain enough time steps to discern the higher level of seasonalities, since at least two full cycles are required to conclude there to be a seasonality. As trends should be described after seasonalities are removed, for each dataset, we also aggregate multiple time steps into one time step in order to introduce samples with more diversified patterns.

In some example configurations, the training module 214 may take additional steps to further increase the number of training pairs in a cost-efficient manner. For example, for each labeled training pair, the training module 214 additionally apply different random augmentations to the original time-series window Wₖ such that the trend description is still applicable to the augmented samples. The augmentations may include jittering, scaling, shifting, smoothing, downsampling, upsampling, etc. The training module 214 then rephrases the original description generated by the large language model using an additional model in order to increase the language diversity. Therefore, for each training sample, the training module 214 generates nine augmented samples

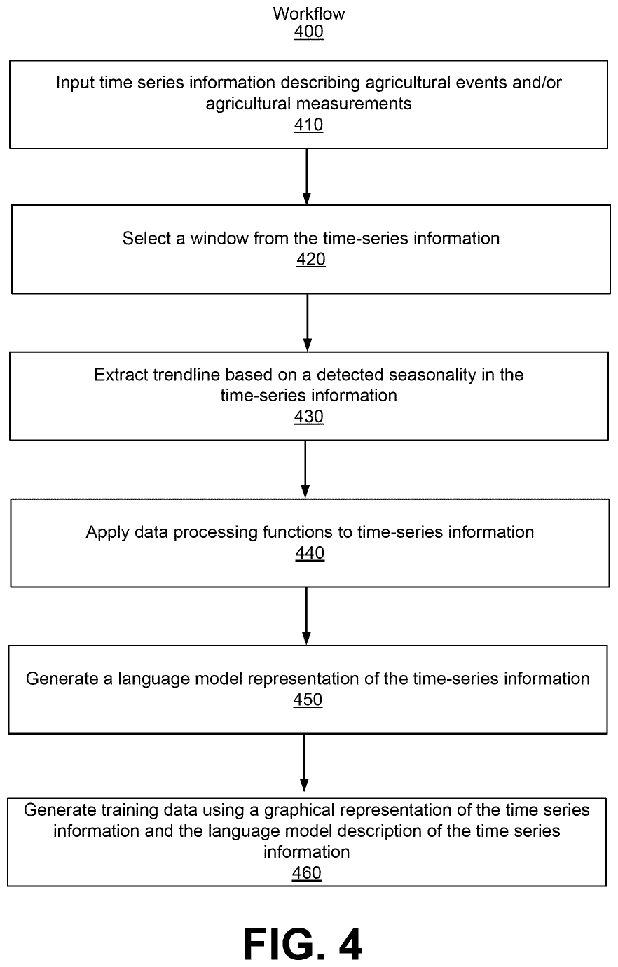

To demonstrate, FIG. 4 illustrates a workflow for generating training an insight miner, in accordance with one or more example embodiments. The workflow 300 may include additional or fewer steps, and the steps may occur in a different order. One or more of the stops may be repeated or omitted depending on the circumstances.

In this example, a training module (e.g., training module 214) trains an insight miner to generate insights about time-series agricultural information, but other domains are also possible.

The training module inputs 410 time-series information agricultural information. The agricultural information may include time-series data describing agricultural events and/or agricultural measurements. For instance, the time-series data may describe a date that a planting occurs, a tilling occurs, irrigation timings, etc. Additionally, the time-series data may include, e.g., sensor measurements such as speed and pressure, or general agronomy measurements such as nitrogen levels or yield calculations.

The training module selects 420 a time window from the time-series information. For instance, the training module may select a day, a week, a month, a year, etc. as a time window for the times series information. In doing so, the training module focuses on the time window while ignoring (or using at a later time) the data outside of the time window.

The training module extracts 430 trendline based on a detected seasonality in the time-series information. More specifically, if the training model identifies a seasonality, it extracts a trendline using an STL approach as described above. If the training module identifies there is no seasonality, it extracts a trendline using a GP approach. The generated data may be paired with a visualization of that data.

The training module applies 440 data processing functions to the time-series from the extracted time-series information. The data processing function may include, e.g., smoothing, downsampling, upsampling, etc. Again, the processed data may be paired with a visualization of that data.

The training module generates 450 a language model representation of the time-series information and/or the trendline of the time-series information. For example, the training module may feed the time-series information into a large language model with a prompt for generating an appropriate natural language description of that trendline (e.g., an insight).

The training module generates 460 training pairs including a visual representation of the time-series information and the generated natural language response describing a trend in the time-series information. The training module trains an insight miner to identify insights using the training pairs.

### VI. Example Agricultural Use Cases

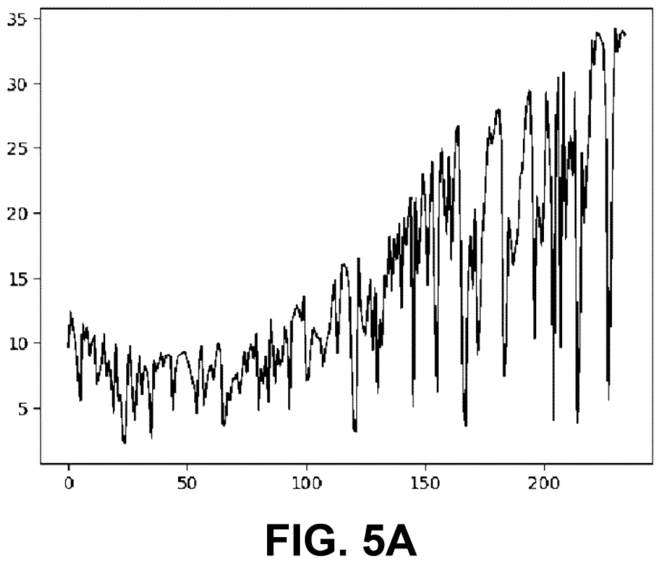

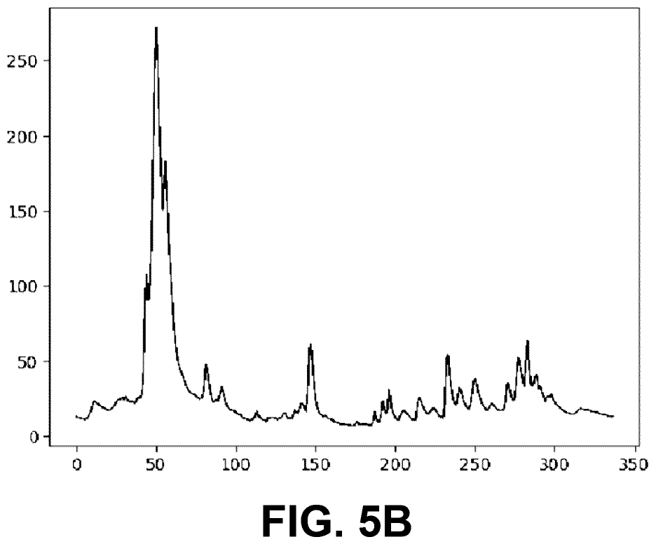

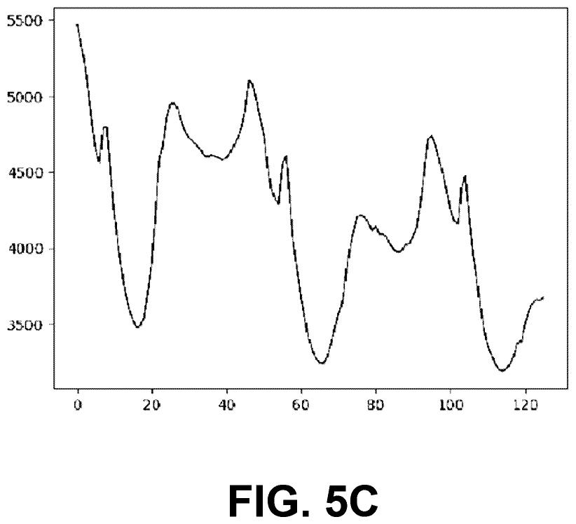

To provide some context, FIGS. 5A, 5B, and 5C illustrate time-series information and an insight generated from an insight miner based on that time-series information, insights generated from that time-series information.

FIG. 5A illustrates time-series information describing weather information in a field in a time window, in accordance with one or more example embodiments. The insight miner generates an insight comprising a natural language description of that time-series information. As an example, the insight may include “The trend in the time-series data indicates a gradual increase over time.” A typical language model (e.g., a GPT), however, may generate the insight, “The trend in the data shows a general increase over time, with some periods of stability and occasional decreases.” As demonstrated, the GPT insight is incorrect, while the insight miner insight is correct. Based on this insight, the farming machine may identify farming actions to take in the field (e.g., when to plant the field based on the increasing temperature).

FIG. 5B illustrates time-series information describing water flow in an irrigation source for a field in a time window, in accordance with one or more example embodiments. The insight miner generates an insight comprising a natural language description of that time-series information. As an example, the insight might include, “The trend in the time-series starts with a sharp increase, then a sharp decrease, followed by a period of stability, a slight increase, and finally a slight increase.” Based on this insight, the farming machine may identify farming actions to take in the field (e.g., setting an irrigation schedule for the field).

FIG. 5C illustrates time-series information describing the power demand of a farming machine in a field in a time window, in accordance with one or more example embodiments. The insight miner generates an insight comprising a natural language description of that time-series information. As an example, the insight might include, “The trend shows a consistent gradual decrease over time, with variability throughout that decrease.” Based on this insight, the farming machine may identify farming actions to take in the field (e.g., managing power usage from various components on the farming machine).

### VII. Example Use Cases in Other Industries

Notably, the insight miner (e.g., insight miner 212) described hereinabove is largely described with a focus on agronomy and time-series agronomy information. However, the insight miner may be applied to various other fields and apparatuses such as, e.g., construction, forestry, health, logistics, etc.

### IX. Control System

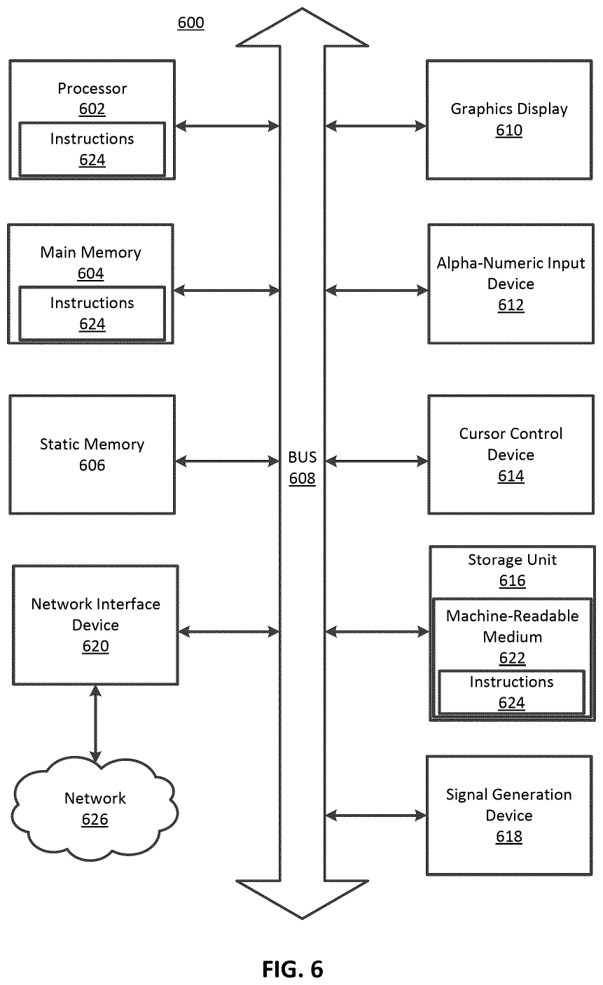

FIG. 6 is a block diagram illustrating components of an example machine for reading and executing instructions from a machine-readable medium, in accordance with an example embodiment. Specifically, FIG. 6 shows a diagrammatic representation of a control system (e.g., control system 130, 210) in the example form of a computer system 600. The computer system 600 can be used to execute instructions 624 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes one or more processing units (generally processor 602). The processor 602 is, for example, one or more central processing units (CPUs), one or more graphics processing units (GPUs), one or more digital signal processors (DSPs), one or more controllers, one or more state machines, one or more application specific integrated circuits (ASICs), one or more radio-frequency integrated circuits (RFICs), or any combination of these. The computer system 600 also includes a main memory 604. The computer system may include a storage unit 616. The processor 602, memory 604, and the storage unit 616 communicate via a bus 608.

In addition, the computer system 600 can include a static memory 606, a graphics display 610 (e.g., to drive a plasma display panel (PDP), a liquid crystal display (LCD), or a projector). The computer system 600 may also include alphanumeric input device 612 (e.g., a keyboard), a cursor control device 614 (e.g., a mouse, a trackball, a joystick, a motion sensor, or other pointing instrument), a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. For example, the instructions 624 may include the functionalities of modules of the system 130 described in FIG. 2. The instructions 624 may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 may be transmitted or received over a network 626 (e.g., network 240) via the network interface device 520.

### X. Additional Considerations

In the description above, for purposes of explanation, numerous specific details are set forth in order to provide a thorough understanding of the illustrated system and its operations. It will be apparent, however, to one skilled in the art that the system can be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. Furthermore, it has also proven convenient at times, to refer to arrangements of operations as modules, without loss of generality. The described operations and their associated modules may be embodied in software, firmware, hardware, or any combinations thereof.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer. This computer may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMS, EEPROMs, magnetic or optical cards, or any type of non-transitory computer readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. A method for performing one or more farming actions in a field, the method comprising:
accessing agricultural information comprising time-series information describing agricultural events or agricultural measurements;
generating a graphical representation of the agricultural information, the graphical representation displaying the time-series information;
applying an insight identification model to the graphical representation of the agricultural information to generate a language response describing the agricultural information therein, the insight identification model:
generating a language embedding of the graphical representation by inputting the graphical representation into a vision encoder; and
generating the language response describing the time-series information by inputting the language embedding and natural language instructions into a language model; and
performing, with a farming machine, the one or more farming actions in the field based on the language response from the insight identification model.

2. The method of claim 1, further comprising:
receiving, from a manager of the field or an operator of the farming machine, natural language instructions for the language response.

3. The method of claim 2, wherein accessing the agricultural information further comprises:
determining, based on the natural language instructions, one or more data sources for the time-series information; and
accessing, from the determined one or more data sources, the agricultural information.

4. The method of claim 1, further comprising:
generating, from the agricultural information, one or more time windows, each of the one or more time windows comprising a temporal subset of the time-series information; and
wherein the graphical representation of the agricultural information comprises the temporal subset of the time-series information.

5. The method of claim 1, further comprising:
applying one or more pre-processing functions to the agricultural information to modify the agricultural information before the graphical representation is generated.

6. The method of claim 1, further comprising:
identifying, based on the language response describing the agricultural information in the graphical representation, the one or more farming actions to perform in the field.

7. The method of claim 6, wherein identifying the one or more farming actions comprises:
transmitting the language response to an operator of the farming machine or a manager of the field; and
responsive to the transmission, receiving the one or more farming actions to perform in the field.

8. The method of claim 6, further comprising:
accessing additional information describing a state of the farming machine; and
applying an action identification model to the language response and the additional information to identify the one or more farming actions.

9. The method of claim 1, further comprising:
training the insight identification model by:
accessing a plurality of time-series information datasets;
for each time-series information dataset of the plurality of time-series information datasets,
selecting a time window for the time-series information dataset,
extracting a trendline for the time-series information dataset based on a detected seasonality in the time-series information,
generating a language model representation of the trendline,
generating a visual representation of the time-series information, and
creating a training pair comprising the visual representation of the time-series information and the language model representation of the trendline; and
training the insight identification model using training pairs for each time-series dataset of the plurality of time-series information datasets.

10. The method of claim 1, wherein the insight identification model is a multimodal model, and generating the language embedding of the graphical representation further comprises:
mapping, using a linear projection layer of the vision encoder of the insight identification model, the graphical representation to a language embedding space to generate the language embedding.

11. A farming machine comprising:
one or more sensors configured for capturing measurements comprising time-series information describing agricultural information in a field;
one or more components configured for performing one or more farming actions in the field;
one or more processors;
a non-transitory computer-readable storage medium storing computer program instructions for performing one or more farming actions in a field, the computer program instructions, when executed by the one or more processors, causing the one or more processors to:
access, from the one or more sensors, agricultural information comprising time-series information describing agricultural measurements;
generate a graphical representation of the agricultural information, the graphical representation displaying the time-series information;
apply an insight identification model to the graphical representation of the agricultural information to generate a language response describing the agricultural information therein, the insight identification model:
generate a language embedding of the graphical representation by inputting the graphical representation into a vision encoder; and
generate the language response describing the time-series information by inputting the language embedding and natural language instructions into a language model; and
perform, with the one or more components, the one or more farming actions in the field based on the language response from the insight identification model.

12. The farming machine of claim 11, wherein the computer program instructions, when executed by the one or more processors, cause the one or more processors to:
receive, from a manager of the field or an operator of the farming machine, natural language instructions for the language response.

13. The farming machine of claim 12, wherein accessing the agricultural information further causes the one or more processors to:
determine, based on the natural language instructions, one or more data sources for the time-series information; and
access, from the determined one or more data sources, the agricultural information.

14. The farming machine of claim 11, wherein the computer program instructions, when executed by the one or more processors, cause the one or more processors to:
generate, from the agricultural information, one or more time windows, each of the time windows comprising a temporal subset of the time-series information; and
wherein the graphical representation of the agricultural information comprises the temporal subset of the time-series information.

15. The farming machine of claim 11, wherein the computer program instructions, when executed by the one or more processors, cause the one or more processors to:
applying one or more pre-processing functions to the agricultural information to modify the agricultural information before the graphical representation is generated.

16. The farming machine of claim 11, further comprising:
identifying, based on the language response describing the agricultural information in the graphical representation, the one or more farming actions to perform in the field.

17. The farming machine of claim 16, wherein identifying the one or more farming actions causes the one or more processors to:
transmit the language response to an operator of the farming machine or a manager of the field; and
responsive to the transmission, receive the one or more farming actions to perform in the field.

18. The farming machine of claim 16, wherein identifying the one or more farming actions causes the one or more processors to:
access additional information describing a state of the farming machine; and
apply an action identification model to the language response and the additional information to identify the one or more farming actions.

19. The farming machine of claim 11, wherein the insight identification model is a multimodal model, and generating the language embedding of the graphical representation causes the one or more processors to:
mapping, using a linear projection layer of the vision encoder of the insight identification model, the graphical representation to a language embedding space to generate the language embedding.

20. A non-transitory computer-readable storage medium storing computer program instructions for performing one or more farming actions in a field, the computer program instructions, when executed by one or more processors, causing the one or more processors to:
access agricultural information comprising time-series information describing agricultural measurements;
generate a graphical representation of the agricultural information, the graphical representation displaying the time-series information;
apply an insight identification model to the graphical representation of the agricultural information to generate a language response describing the agricultural information therein, the insight identification model:
generating a language embedding of the graphical representation by inputting the graphical representation into a vision encoder; and
generating the language response describing the time-series information by inputting the language embeddings and natural language instructions into a language model; and
perform, with a farming machine, the one or more farming actions in the field based on the language response from the insight identification model.
